(19) United States
(12) Patent Application Publication
(10) Pub. No.: US 2025/0045573 A1
(43) Pub. Date: Feb. 6, 2025

(54) DECIMAL-BIT NETWORK QUANTIZATION OF CONVOLUTIONAL NEURAL NETWORK MODELS

(71) Applicant: Intel Corporation, Santa Clara, CA (US)

(72) Inventors: Anbang YAO, Beijing (CN); Yikai WANG, Shanghai (CN); Zhaole SUN, Shanghai (CN); Yi YANG, Shanghai (CN); Feng CHEN, Shanghai (CN); Zhuo WANG, Beijing (CN); Shandong WANG, Beijing (CN); Yurong CHEN, Beijing (CN)

(21) Appl. No.: 18/709,267

(22) PCT Filed: Mar. 3, 2022
(86) PCT No.: PCT/CN2022/078949

§ 371 Date: May 10, 2024

(51) Int. Cl. G06N 3/0495; G06N 3/0464

(52) U.S. Cl. CPC G06N 3/0495; G06N 3/0464

(57) ABSTRACT

The disclosure relates to decimal-bit network quantization of CNN models. Methods, apparatus, systems, and articles of manufacture for quantizing a CNN model includes, for a convolutional layer of the CNN model: allocating a 1-bit convolutional kernel subset to the convolutional layer, wherein the convolutional layer includes 32-bit or 16-bit floating-point convolutional kernels with a size of K×K and the 1-bit convolutional kernel subset includes 2^{N} 1-bit convolutional kernel candidates with the size of K×K, 1≤N<K×K and both K and N being positive integers; and performing weights quantization of the convolutional layer by selecting 1-bit convolutional kernel candidates from the 1-bit convolutional kernel subset as 1-bit convolutional kernels of the convolutional layer

### TECHNICAL FIELD

Embodiments described herein generally relate to the field of neural network, and more particularly relate to decimal-bit network quantization of Convolutional Neural Network (CNN) models.

### BACKGROUND

Convolutional Neural Network (CNN) models are powerful learning models that achieve state-of-the-art performance on many computer vision tasks. The CNN models include an input layer, an output layer and at least one hidden layer in between and use sophisticated mathematical modeling to process data transferred among these network layers.

### BRIEF DESCRIPTION OF THE DRAWINGS

The various advantages of the embodiments will become apparent to one skilled in the art by reading the following specification and appended claims, and by referencing the following drawings, in which:

FIG. 1 is a flow diagram illustrating a method for quantizing a CNN model in accordance with some embodiments of the disclosure;

FIG. 2 is a diagram illustrating an example 1-bit convolutional kernel subset in accordance with some embodiments of the disclosure;

FIG. 3 is a diagram illustrating the speed up of the decimal-bit CNN model against the 1-bit CNN model in accordance with some embodiments of the disclosure;

FIG. 4 is a flow diagram illustrating a method for training a CNN model in accordance with some embodiments of the disclosure;

FIG. 5 is a block diagram illustrating components, according to some example embodiments, able to read instructions from a machine-readable or computer-readable medium and perform any one or more of the methodologies discussed herein;

FIG. 6 is a block diagram of an example processor platform in accordance with some embodiments of the disclosure; and

FIG. 7A is a diagram illustrating various layers within a CNN model.

FIG. 7B is a diagram illustrating exemplary computation stages within a convolutional layer of a CNN model.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

A CNN model is a specialized feedforward neural network model for processing data having a known, grid-like topology, such as image data. Accordingly, CNN models are commonly used for compute vision and image recognition applications, but they also may be used for other types of pattern recognition such as speech and language processing.

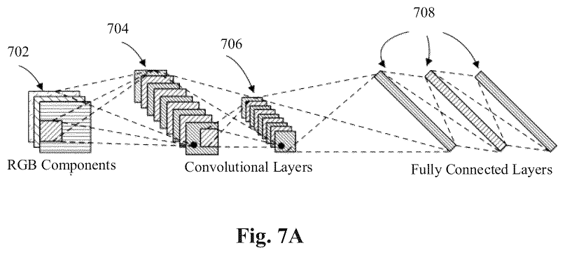

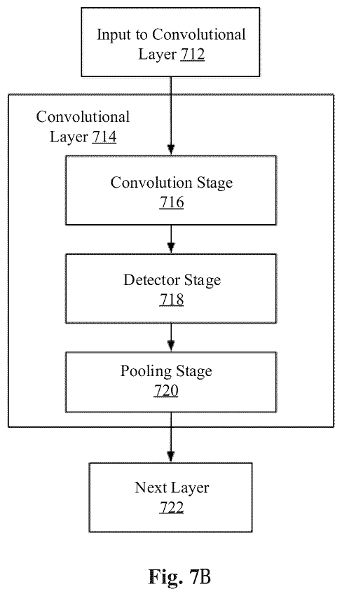

FIG. 7A is a diagram illustrating various layers within a CNN model. As shown in FIG. 7A, an exemplary CNN model used to model image processing can receive input 702 describing Red, Green, and Blue (RGB) components of an input image. The input 702 can be processed by multiple convolutional layers (e.g., first convolutional layer 704, second convolutional layer 706). The output from the multiple convolutional layers may optionally be processed by a set of fully connected layers 708. Neurons in a fully connected layer have full connections to all activations in the previous layer, as previously described for a feedforward network. The output from the fully connected layers 708 can be used to generate an output result from the network. The activations within the fully connected layers 708 can be computed using matrix multiplication instead of convolution. Not all CNN implementations make use of fully connected layers 708. For example, in some implementations the second convolutional layer 706 can generate output for the CNN model.

The convolutional layers are sparsely connected, which differs from traditional neural network configuration found in the fully connected layers 708. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The convolutional kernels associated with the convolutional layers perform convolution operations, the output of which is sent to the next layer. The dimensionality reduction performed within the convolutional layers is one aspect that enables the CNN model to scale to process large images.

FIG. 7B is a diagram illustrating exemplary computation stages within a convolutional layer of a CNN model. Input to a convolutional layer 712 of a CNN model can be processed in three stages of a convolutional layer 714. The three stages can include a convolution stage 716, a detector stage 718, and a pooling stage 720. The convolution layer 714 can then output data to a successive convolutional layer. The final convolutional layer of the network can generate output feature map data or provide input to a fully connected layer, for example, to generate a classification value for the input to the CNN model.

In the convolution stage 716 performs several convolutions in parallel to produce a set of linear activations. The convolution stage 716 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 716 defines a set of linear activations that are processed by successive stages of the convolutional layer 714.

The linear activations can be processed by a detector stage 718. In the detector stage 718, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as ƒ(x)=max (0, x), such that the activation is thresholded at zero.

The pooling stage 720 uses a pooling function that replaces the output of the second convolutional layer 706 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 720, including max pooling, average pooling, and l2-norm pooling. Additionally, some CNN implementations do not include a pooling stage. Instead, such implementations substitute and additional convolution stage having an increased stride relative to previous convolution stages.

The output from the convolutional layer 714 can then be processed by the next layer 722. The next layer 722 can be an additional convolutional layer or one of the fully connected layers 708. For example, the first convolutional layer 704 of FIG. 7A can output to the second convolutional layer 706, while the second convolutional layer can output to a first layer of the fully connected layers 708.

CNN models have demonstrated record breaking results in almost all computer vision tasks. Regardless of the availability of a large-scale dataset and powerful hardware resources, the leading performance of the CNN models is attributed to a huge number of learnable parameters, even up to hundreds of millions. However, this in turn brings heavy costs of memory, compute and power, which prohibits their broad usages, especially on resource constrained devices. With the drive to make the CNN models be applicable on mobile or embedded or Graphics Processing Unit (GPU) devices, substantial research efforts have been invested for network quantization of the CNN models both in academia and industry.

An extreme quantization solution of the CNN models is 1-bit network quantization, in which parameters of the CNN models are forced to be 1-bit values {−1, 1}. Specifically, basic concepts of the 1-bit network quantization are the following: assuming M={ƒ(Wₗ, Aₗ; Xₗ)|1≤l≤L} is a 32-bit floating-point CNN model (it should be appreciated that the 32-bit floating-point CNN model is just for example, it may also be a 64-bit or 16-bit floating-point CNN model or a Block Floating-Point (BFP)-16 CNN model), where Wₗ is a 32-bit floating-point weight set of a l-th convolutional layer, Xₗ is an input set of the l-th convolutional layer, Aₗ is an activation set of the l-th convolutional layer, and L is the number of convolutional layers in the 32-bit floating-point CNN model M. The 1-bit network quantization aims to convert the 32-bit floating-point CNN model M into a 1-bit CNN model, which has only a quantized weight set Ŵₗ whose entries are composed of αₗ B, where B∈{1,−1} and αₗ is a positive scaling factor specific to the l-th convolutional layer. Mathematically, an objective function of the 1-bit network quantization of the 32-bit floating-point CNN model M may be defined as follows:

$${arg min}_{{\hat{W}}_{l}} {‖ {\hat{W}}_{l} - {W}_{l} ‖}_{2}^{2} , \qquad ( 1 )$$

$${\hat{W}}_{l} = {α}_{l} B ,$$

$$B ∈ \{ 1 , - 1 \}$$

The optimization of the objective function (1) may be readily solved with for example, a popular Straight-Through Estimator (STE).

As compared with the 32-bit floating-point CNN model, the 1-bit network quantization brings significant storage and latency reductions (32× compression and at most 58× speed-up) by replacing originally time-intensive multiplication operations by cheap bitwise XNOR and Bitcount operations, easing deployment of CNN solutions, especially with specialized Artificial Intelligent (AI) devices.

Existing 1-bit network quantization solutions including but not limited to Binary-Weight-Network (BWN), DoReFa-Net, XNOR-Net, Ternary-Binary Network (TBN), Loss-aware Binary Network (LBN), Explicit Loss-error-aware Quantization (ELQ), Learned Quantization (LQ)-Net, Differentiable Soft Quantization (DSQ) and Information Retention (IR)-Net, focus on binary quantization scheme designs, aiming to get binary networks with high accuracy.

Benefiting from recent great advances on binary network design, modern binary networks have small accuracy drop against full-precision reference models. For single-class or multi-class vision applications like face detection/verification, pedestrian/human detection, etc., 1-bit CNN models have been popular used as the accuracy drop is negligible (usually less than 1%). However, so far, there is no solution tailored to compression and speed-up of the 1-bit CNN models without loss of model accuracy.

The disclosure proposes Decimal-Bit Network Quantization (DebNeQ) for compression and speed-up of the 1-bit CNN models without loss of model accuracy.

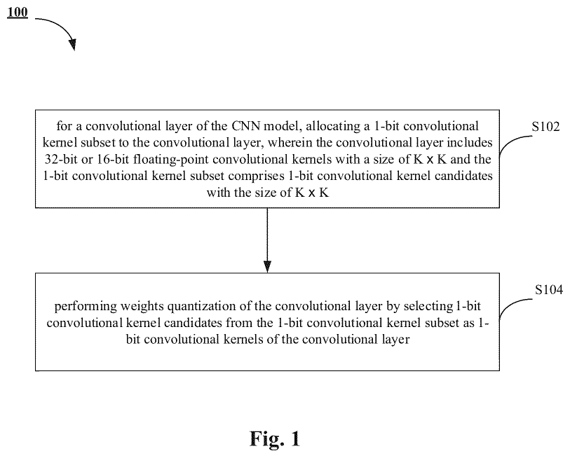

FIG. 1 is a flow diagram illustrating a method 100 for quantizing a CNN model in accordance with some embodiments of the disclosure. As shown in FIG. 1, the method 100 includes, for a convolutional layer of the CNN model: S102, allocating a 1-bit convolutional kernel subset to the convolutional layer, wherein the convolutional layer includes 32-bit or 16-bit floating-point convolutional kernels with a size of K×K and the 1-bit convolutional kernel subset includes 2^{N} 1-bit convolutional kernel candidates with the size of K×K, 1≤N<K×K and both K and N being positive integers; and S104, performing weights quantization of the convolutional layer by selecting 1-bit convolutional kernel candidates from the 1-bit convolutional kernel subset as 1-bit convolutional kernels of the convolutional layer.

As compared with the 1-bit CNN models, the CNN model resulting from the quantization of the method 100 is compressed about K×K/N times, and accordingly the quantization of the method 100 is called the DebNeQ and the CNN model resulting from the quantization of the method 100 is called decimal-bit CNN model.

Specifically, in the 1-bit CNN models, a 1-bit convolutional kernel with the size of K×K needs K×K bits to represent all its weights, and there are a total of 2^{K×K} 1-bit convolutional kernel candidates for the 1-bit convolutional kernel according to the layout of {1,−1} values. In contrast, in the decimal-bit CNN model, the number of 1-bit convolutional kernel candidates for the 1-bit convolutional kernel is forced to be 2^{N}, 1≤N<K×K, in average, representing all weights of the 1-bit convolutional kernel with the size of K×K just needs N bits instead of K×K bits.

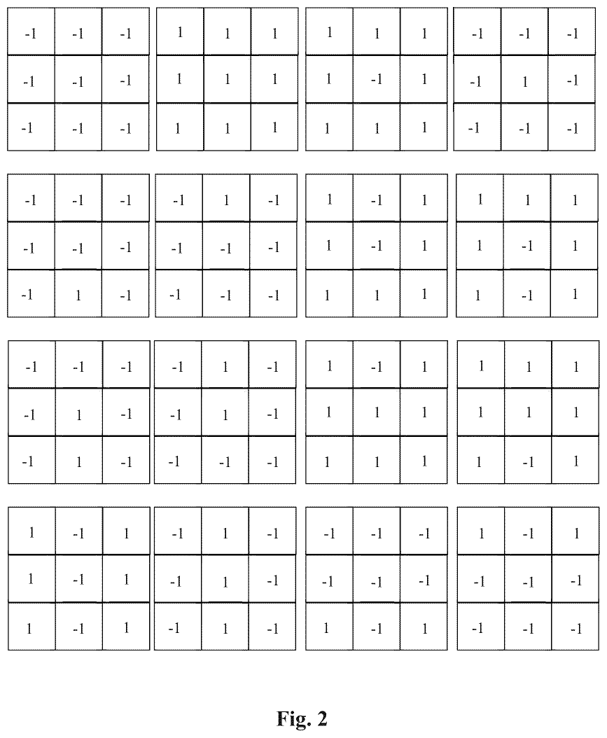

FIG. 2 is a diagram illustrating an example 1-bit convolutional kernel subset in accordance with some embodiments of the disclosure. As shown in FIG. 2, the example 1-bit convolutional kernel subset includes 2⁴=16 1-bit convolutional kernel candidates with a size of 3×3. When the example 1-bit convolutional kernel subset is allocated to a convolutional layer including 32-bit or 16-bit floating-point convolutional kernels with the size of 3×3 of the CNN model, the 1-bit convolutional kernel candidates may be selected from the example 1-bit convolutional kernel subset as the 1-bit convolutional kernels of the convolutional layer, and 4 bits instead of 9 bits are needed to represent all weights of each of the 1-bit convolutional kernels.

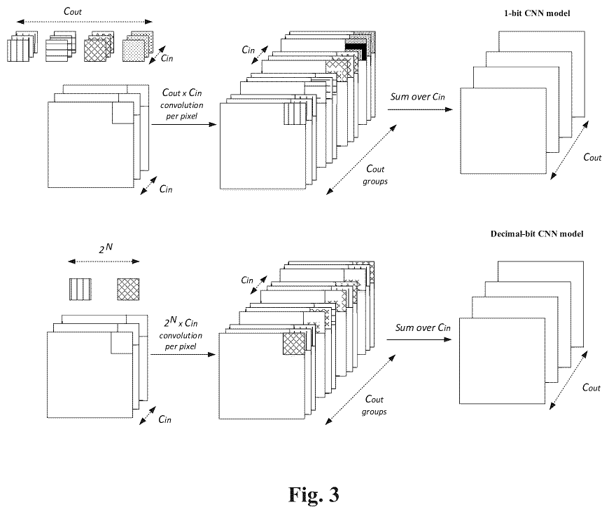

Moreover, the DebNeQ also converts a computational flow for CNN inference in a shared manner, bringing impressive speed-up against the 1-bit CNN models. For example, assuming Cₒᵤₜ is the number of output feature channels for the convolutional layer and Cᵢₙ is the number of input feature channels for the convolutional layer. In the 1-bit CNN models, K×K kernel-wise 1-bit convolutional operations per pixel is performed for Cₒᵤₜ×Cᵢₙ times. In contrast, in the decimal-bit CNN model, the K×K kernel-wise 1-bit convolutional operations per pixel is performed for 2^{N}×Cᵢₙ times as the 2^{N} 1-bit convolutional kernel candidates are shared to all convolutional kernels each corresponding to one of the output feature channels, 2^{N}<<cₒᵤₜ. FIG. 3 is a diagram illustrating the speed up of the decimal-bit CNN model against the 1-bit CNN model in accordance with some embodiments of the disclosure.

In some embodiments, the 1-bit convolutional kernel subset may be shared to all convolutional layers of the CNN model or specific to the convolutional layer. The 1-bit convolutional kernel subsets allocated to different convolutional layers of the CNN model may include the same number of 1-bit convolutional kernel candidates or different numbers of 1-bit convolutional kernel candidates. The 1-bit convolutional kernel candidates of the 1-bit convolutional kernel subset may be predefined or randomly selected from a 1-bit convolutional kernel set including all possible 1-bit convolutional kernel candidates or a part of them.

In some embodiments, the objective function of network quantization of the CNN model may be defined as follows:

$${arg min}_{{\hat{W}}_{l}} {‖ {\hat{W}}_{l} - {W}_{l} ‖}_{2}^{2} , \qquad ( 2 )$$

$${\hat{W}}_{l} ∈ P ,$$

$$P = \{ {w}_{1} , {w}_{2} , … , {w}_{{2}^{N}} \}$$

wherein P={w₁, w₂, . . . , w₂_{^{N}}} is the 1-bit convolutional kernel subset, Wₗ is the quantized weight set of the convolutional layer, and Wi is the 32-bit or 16-bit floating-point weight set of the convolutional layer.

As described above, the DebNeQ is use to convert the CNN model from a 32-bit or 16-bit floating-point model to a decimal-bit model, and is a technique for compression and speed-up of the 1-bit CNN models. Furthermore, the decimal-bit CNN model, being a new quantized CNN model, may be used for advanced AI HW/accelerator designs for efficient deep learning inference.

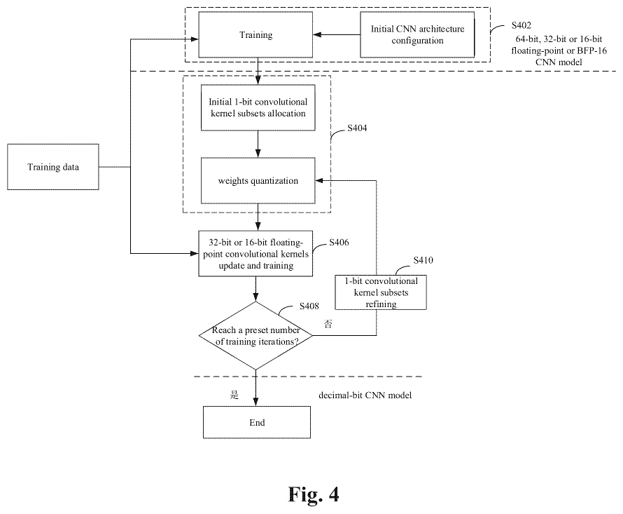

FIG. 4 is a flow diagram illustrating a method 400 for training a CNN model in accordance with some embodiments of the disclosure. As shown in FIG. 4, the method 400 includes: S402, training an initial CNN architecture configuration based on training data to generate a CNN model, which is a 32-bit or 16 bit floating-point model; S404, for a convolutional layer of the CNN model, allocating a 1-bit convolutional kernel subset to the convolutional layer, wherein the convolutional layer includes 32-bit or 16-bit floating-point convolutional kernels with a size of K×K and the 1-bit convolutional kernel subset includes 2^{N} 1-bit convolutional kernel candidates with the size of K×K, 1≤N<K×K, performing weights quantization of the convolutional layer by selecting 1-bit convolutional kernel candidates from the 1-bit convolutional kernel subset as 1-bit convolutional kernels of the convolutional layer; and S406, updating 32-bit or 16-bit floating-point convolutional kernels of respective convolutional layers of the CNN model and training the CNN model.

In some embodiments, the method 400 further includes: S408, determining whether the number of training iterations for the CNN model reaches a preset iteration number; and S410, when the number of training iteration iterations for the CNN model does not reach the preset iteration number, for the convolutional layer of the CNN model, refining the 1-bit convolutional kernel subset, and then returning to S404 to perform weights quantization of the convolutional layer by selecting 1-bit convolutional kernel candidates from the refined 1-bit convolutional kernel subset as the 1-bit convolutional kernels of the convolutional layer, wherein the refined 1-bit convolutional kernel subset includes 2^{N} 1-bit convolutional kernel candidates with the size of K×K.

Extensive experiments indicates that there is no loss of model accuracy of the decimal-bit CNN model as compared with the 1-bit CNN models.

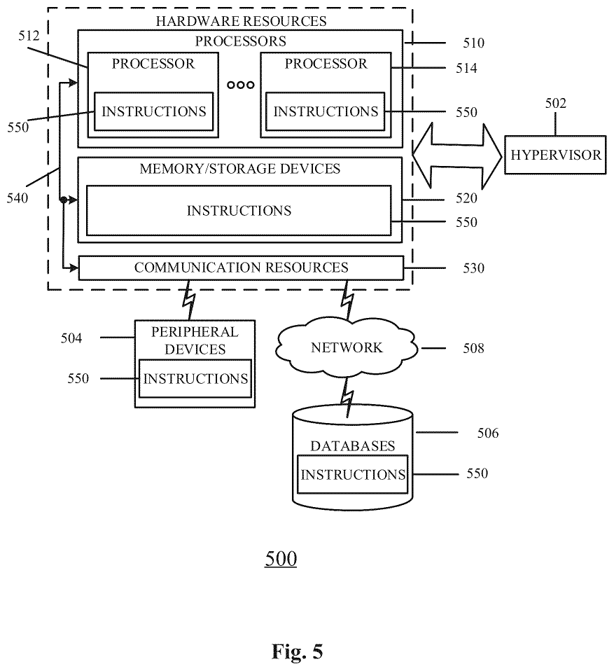

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 520 may include main memory, disk storage, or any suitable combination thereof. The memory/storage devices 520 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 530 may include interconnection or network interface components or other suitable devices to communicate with one or more peripheral devices 504 or one or more databases 506 via a network 508. For example, the communication n resources 530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

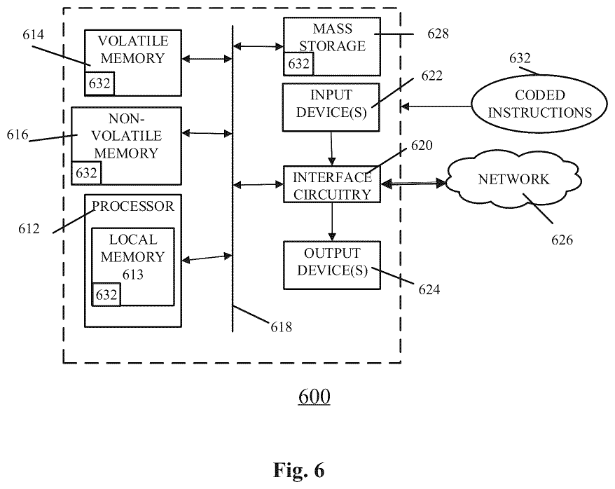

FIG. 6 is a block diagram of an example processor platform in accordance with some embodiments of the disclosure. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes interface circuitry 620. The interface circuitry 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuitry 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 620 of the illustrated example, thus, typically includes a graphics driver card, a graphics driver chip and/or a graphics driver processor.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 620 may include a training dataset inputted through the input device(s) 622 or retrieved from the network 626.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives.

Machine executable instructions 632 may be stored in the mass storage device 628, in the volatile memory 614, in the non-volatile memory 616, and/or on a removable non-transitory computer readable storage medium such as a CD or DVD.

### ADDITIONAL NOTES AND EXAMPLES

Example 1 includes a method for quantizing a Convolutional Neural Network (CNN) model, comprising, for a convolutional layer of the CNN model: allocating a 1-bit convolutional kernel subset to the convolutional layer, wherein the convolutional layer comprises 32-bit or 16-bit floating-point convolutional kernels with a size of K×K and the 1-bit convolutional kernel subset comprises 2^{N} 1-bit convolutional kernel candidates with the size of K×K, 1≤N<K×K; and performing weights quantization of the convolutional layer by selecting 1-bit convolutional kernel candidates from the 1-bit convolutional kernel subset as 1-bit convolutional kernels of the convolutional layer.

Example 2 includes the method of Example 1, wherein the 1-bit convolutional kernel subset is shared to all convolutional layers of the CNN model.

Example 3 includes the method of Example 1, wherein the 1-bit convolutional kernel subset is specific to the convolutional layer.

Example 4 includes the method of Example 3, wherein 1-bit convolutional kernel subsets allocated to different convolutional layers of the CNN model comprises the same number of 1-bit convolutional kernel candidates.

Example 5 includes the method of Example 3, wherein 1-bit convolutional kernel subsets allocated to different convolutional layers of the CNN model comprises different numbers of 1-bit convolutional kernel candidates.

Example 6 includes the method of Example 1, wherein the 1-bit convolutional kernel candidates of the 1-bit convolutional kernel subset are predefined.

Example 7 includes the method of Example 1, wherein the 1-bit convolutional kernel candidates of the 1-bit convolutional kernel subset are randomly selected from a 1-bit convolutional kernel set comprising all possible 1-bit convolutional kernel candidates or a part of them.

Example 8 includes the method of Example 1, wherein an objective function of network quantization of the CNN model is defined as follows:

$${arg min}_{{\hat{W}}_{l}} {‖ {\hat{W}}_{l} - {W}_{l} ‖}_{2}^{2} ,$$

$${\hat{W}}_{l} ∈ P ,$$

$$P = \{ {w}_{1} , {w}_{2} , … , {w}_{{2}^{N}} \}$$

wherein P={w₁, w₂, . . . , w₂_{^{N}}} is the 1-bit convolutional kernel subset, Ŵₗ is a quantized weight set of the convolutional layer, and Wₗ is a 32-bit or 16-bit floating-point weight set of the convolutional layer.

Example 9 includes a method of training a Convolutional Neural Network (CNN) model, comprising: for a convolutional layer of the CNN model, allocating a 1-bit convolutional kernel subset to the convolutional layer, wherein the convolutional layer comprises 32-bit or 16-bit floating-point convolutional kernels with a size of K×K and the 1-bit convolutional kernel subset comprises 2^{N} 1-bit convolutional kernel candidates with the size of K×K, 1≤N<K×K, performing weights quantization of the convolutional layer by selecting 1-bit convolutional kernel candidates from the 1-bit convolutional kernel subset as 1-bit convolutional kernels of the convolutional layer; and updating 32-bit or 16-bit floating-point convolutional kernels of respective convolutional layers of the CNN model.

Example 10 includes the method of Example 9, further comprising: when a number of training iterations for the CNN model does not reach a preset iteration number, for the convolutional layer of the CNN model, refining the 1-bit convolutional kernel subset, and performing weights quantization of the convolutional layer by selecting 1-bit convolutional kernel candidates from the refined 1-bit convolutional kernel subset as the 1-bit convolutional kernels of the convolutional layer, wherein the refined 1-bit convolutional kernel subset comprises 2^{N} 1-bit convolutional kernel candidates with the size of K×K.

Example 11 includes the method of Example 9, wherein the 1-bit convolutional kernel subset is shared to all convolutional layers of the CNN model.

Example 12 includes the method of Example 9, wherein the 1-bit convolutional kernel subset is specific to the convolutional layer.

Example 13 includes the method of Example 12, wherein 1-bit convolutional kernel subsets allocated to different convolutional layers of the CNN model comprises the same number of 1-bit convolutional kernel candidates.

Example 14 includes the method of Example 12, wherein 1-bit convolutional kernel subsets allocated to different convolutional layers of the CNN model comprises different numbers of 1-bit convolutional kernel candidates.

Example 15 includes the method of Example 9, wherein the 1-bit convolutional kernel candidates of the 1-bit convolutional kernel subset are predefined.

Example 16 includes the method of Example 9, wherein the 1-bit convolutional kernel candidates of the 1-bit convolutional kernel subset are randomly selected from a 1-bit convolutional kernel set comprising all possible 1-bit convolutional kernel candidates or a part of them.

Example 17 includes the method of Example 9, wherein an objective function of network quantization of the CNN model is defined as follows:

$${arg min}_{{\hat{W}}_{l}} {‖ {\hat{W}}_{l} - {W}_{l} ‖}_{2}^{2} ,$$

$${\hat{W}}_{l} ∈ P ,$$

$$P = \{ {w}_{1} , {w}_{2} , … , {w}_{{2}^{N}} \}$$

wherein P={w₁, w₂, . . . , w₂_{^{N}}} is the 1-bit convolutional kernel subset, Ŵₗ is a quantized weight set of the convolutional layer, and Wₗ is a 32-bit or 16-bit floating-point weight set of the convolutional layer.

Example 18 includes a computer-readable medium having instructions stored thereon, wherein the instructions, when executed by processor circuitry, cause the processor circuitry to perform the method of any of claims 1 to 17.

Example 19 includes an apparatus for a Convolutional Neural Network (CNN), comprising means for performing the method of any of claims 1 to 17.

Example 20 includes an apparatus for a Convolutional Neural Network (CNN), comprising: memory having instructions stored thereon; and processor circuitry coupled to the memory, wherein the instructions, when executed by the processor circuitry, cause the processor circuitry to perform the method of any of claims 1 to 17.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. An apparatus, comprising:
memory;
computer executable instructions; and
processor circuitry to be programmed by the computer executable instructions to, for a convolutional layer of the CNN model:
allocate a 1-bit convolutional kernel subset to the convolutional layer, wherein the convolutional layer includes 32-bit or 16-bit floating-point convolutional kernels with a size of K×K and the 1-bit convolutional kernel subset includes 2^{N} 1-bit convolutional kernel candidates with the size of K×K, 1≤N<K×K and both K and N are positive integers; and
perform weights quantization of the convolutional layer by selecting 1-bit convolutional kernel candidates from the 1-bit convolutional kernel subset as 1-bit convolutional kernels of the convolutional layer.

22. The apparatus of claim 21, wherein the processor circuitry is to update 32-bit or 16-bit floating-point convolutional kernels of respective convolutional layers of the CNN model.

23. The apparatus of claim 22, wherein the processor circuitry is to:
when a number of training iterations for the CNN model does not reach a preset iteration number, for the convolutional layer of the CNN model,
refine the 1-bit convolutional kernel subset, and
perform weights quantization of the convolutional layer by selecting 1-bit convolutional kernel candidates from the refined 1-bit convolutional kernel subset as the 1-bit convolutional kernels of the convolutional layer,
the refined 1-bit convolutional kernel subset includes 2^{N} 1-bit convolutional kernel candidates with the size of K×K.

24. The apparatus of claim 21, wherein the 1-bit convolutional kernel subset is shared to all convolutional layers of the CNN model.

25. The apparatus of claim 21, wherein the 1-bit convolutional kernel subset is specific to the convolutional layer.

26. The apparatus of claim 25, wherein 1-bit convolutional kernel subsets allocated to different convolutional layers of the CNN model include the same number of 1-bit convolutional kernel candidates.

27. The apparatus of claim 25, wherein 1-bit convolutional kernel subsets allocated to different convolutional layers of the CNN model include different numbers of 1-bit convolutional kernel candidates.

28. The apparatus of claim 21, wherein the 1-bit convolutional kernel candidates of the 1-bit convolutional kernel subset are predefined.

29. The apparatus of claim 21, wherein the 1-bit convolutional kernel candidates of the 1-bit convolutional kernel subset are randomly selected from a 1-bit convolutional kernel set including 1-bit convolutional kernel candidates.

30. The apparatus of claim 21, wherein an objective function of network quantization of the CNN model is defined as follows:
$${arg min}_{{\hat{W}}_{l}} {‖ {\hat{W}}_{l} - {W}_{l} ‖}_{2}^{2} ,$$
$${\hat{W}}_{l} ∈ P ,$$
$$P = \{ {w}_{1} , {w}_{2} , … , {w}_{{2}^{N}} \}$$
wherein P={w₁, w₂, . . . , w₂_{^{N}}} is the 1-bit convolutional kernel subset, Ŵₗ is a quantized weight set of the convolutional layer, and Wₗ is a 32-bit or 16-bit floating-point weight set of the convolutional layer.

31. A non-transitory computer-readable medium comprising computer executable instructions to cause at least one processor circuit to, for a convolutional layer of the CNN model:
allocate a 1-bit convolutional kernel subset to the convolutional layer, wherein the convolutional layer includes 32-bit or 16-bit floating-point convolutional kernels with a size of K×K and the 1-bit convolutional kernel subset includes 2^{N} 1-bit convolutional kernel candidates with the size of K×K, 1≤N<K×K and both K and N are positive integers; and
perform weights quantization of the convolutional layer with 1-bit convolutional kernel candidates from the 1-bit convolutional kernel subset as 1-bit convolutional kernels of the convolutional layer.

32. The non-transitory computer-readable medium of claim 31, wherein the computer executable instructions cause one or more of the at least one processor circuit to update 32-bit or 16-bit floating-point convolutional kernels of respective convolutional layers of the CNN model.

33. The non-transitory computer-readable medium of claim 32, wherein the computer executable instructions cause one or more of the at least one processor circuit to:
when a number of training iterations for the CNN model does not reach a preset iteration number, for the convolutional layer of the CNN model,
refine the 1-bit convolutional kernel subset, and
perform weights quantization of the convolutional layer by selecting 1-bit convolutional kernel candidates from the refined 1-bit convolutional kernel subset as the 1-bit convolutional kernels of the convolutional layer,
the refined 1-bit convolutional kernel subset includes 2^{N} 1-bit convolutional kernel candidates with the size of K×K.

34. The non-transitory computer-readable medium of claim 31, wherein the 1-bit convolutional kernel subset is shared to all convolutional layers of the CNN model.

35. The non-transitory computer-readable medium of claim 31, wherein the 1-bit convolutional kernel subset is specific to the convolutional layer.

36. The non-transitory computer-readable medium of claim 35, wherein 1-bit convolutional kernel subsets allocated to different convolutional layers of the CNN model include the same number of 1-bit convolutional kernel candidates.

37. The non-transitory computer-readable medium of claim 35, wherein 1-bit convolutional kernel subsets allocated to different convolutional layers of the CNN model include different numbers of 1-bit convolutional kernel candidates.

38. The non-transitory computer-readable medium of claim 31, wherein the 1-bit convolutional kernel candidates of the 1-bit convolutional kernel subset are predefined.

39. The non-transitory computer-readable medium of claim 31, wherein the 1-bit convolutional kernel candidates of the 1-bit convolutional kernel subset are randomly selected from a 1-bit convolutional kernel set including all possible 1-bit convolutional kernel candidates or a part of them.

40. The non-transitory computer-readable medium of claim 31, wherein an objective function of network quantization of the CNN model is defined as follows:
$${arg min}_{{\hat{W}}_{l}} {‖ {\hat{W}}_{l} - {W}_{l} ‖}_{2}^{2} ,$$
$${\hat{W}}_{l} ∈ P ,$$
$$P = \{ {w}_{1} , {w}_{2} , … , {w}_{{2}^{N}} \}$$
wherein P={w₁, w₂, . . . , w₂_{^{N}}} is the 1-bit convolutional kernel subset, Ŵₗ is a quantized weight set of the convolutional layer, and Wₗ is a 32-bit or 16-bit floating-point weight set of the convolutional layer.
